(19) United States
(12) Patent Application Publication
(10) Pub. No.: US 2007/0298858 A1
(43) Pub. Date: Dec. 27, 2007

(54) Multi-Player Competition

(76) Inventor: Steve Toneguzzo, Rosebery (AU)

Correspondence Address: MICHAEL MOLINS;MOLINS & CO., SUITE 5, LEVEL 6, 139 MACQUARIE ST, SYDNEY NSW, 2000, AU

(21) Appl. No.: 11/766,795

(22) Filed: Jun. 22, 2007

(30) Foreign Application Priority Data
Jun. 26, 2006 (AU) 2006903407

(51) Int. Cl. G06F 17/00

(52) U.S. Cl. 463/16

(57) ABSTRACT

A multi-player gambling process, which also allows for single-player games, creates multi-player groups, where participants are pre-screened or invited at the discretion of the group initiators. All registered players also participate in reward schemes organized into an electronic voucher system. The electronic voucher systems allow for promotional offers and adjustments to be made by the system operators and vendors of products and services, and are individualized for each player. The players are granted freedom in terms of changing personalized settings for their vouchers and in terms of any-time redemption for all vouchers.

### FIELD OF THE INVENTION

This invention relates to multi-player gaming and more particularly to methods for establishing tournaments that allow two or more players to participate in a gambling game, and for a gaming operator and a winning player to be rewarded for playing.

### BACKGROUND OF THE INVENTION & PRIOR ART

In Casinos and on the Internet and in any other form of technology assisted gambling, a player may play:
a) In isolation (e.g. playing a poker machine),
b) In a loose participation model such as a linked jackpot (e.g. where the poker machines being played are linked to a jackpot and all participating players may be eligible for the jackpot prize), or
c) In a tight participation model where players compete against each other (e.g. Internet Poker).

In the case of (b), two or more players might agree verbally to play the same jackpot machines. In the case of (c), the players are assigned to a particular virtual table by the operator of the game. No prior art includes a scheme which allows player to electronically invite other players to participate in a game.

Additionally, when a player bets money on a game, systems exist that accrue bonus points relative to the value of total bets a player has made since system registration. These points may be redeemed at any time for items of value.

No gaming, wagering or betting system currently provides for the equivalent of configurable electronic vouchers.

### OBJECTS AND SUMMARY OF INVENTION

It is an object of this invention to create a system which maintains customer profiles containing the customer's personal data, gaming, gambling, or betting preferences, and their reward preferences.

This invention also describes a player-invitation scheme which prevents the participation of uninvited players, and allows every registered player the option of creating, by invitation, his or her own multi-player groups.

This invention has an electronic voucher system, which will allow the players freedom in viewing and managing their rewards at any time. The voucher system will also integrate marketing schemes, such as promotional-offers or limited-time discounts, into the reward value calculation and redemption.

### BRIEF DESCRIPTION OF THE DRAWING FIGURES

In order that the invention be better understood, reference is now made to the following drawing figures in which:

FIG. 1 is a flow-chart depicting the multi-player gambling participation process

FIG. 2 is a flow-chart depicting the electronic voucher set-up

FIG. 3 is a flow-chart depicting voucher value assignment

FIG. 4 is a flow-chart depicting voucher reviewing and redeeming

### BEST MODE AND OTHER EMBODIMENTS OF THE INVENTION

This invention describes a multi-user participation scheme and a electronic voucher reward scheme for businesses such as gaming, gambling systems, or other multi customer businesses. The following teaching describes this invention's application in technology-assisted gambling applications. The customers are thus players in the present teaching.

A person who intends to play, or is playing a game, or participating in an event, is called a “player” for the purposes of this invention.

It is envisaged that the following processes would be programmed into one or more software modules that would constitute a “plug in”, “module” or software component of a player loyalty or gambling, gaming, sports betting, wagering or other technology assisted gambling program, application or system. The purposes of the following examples are to provide a method by which a networked tournament style game can be established, by one or more invitations, that stem from a player or the player's invitees.

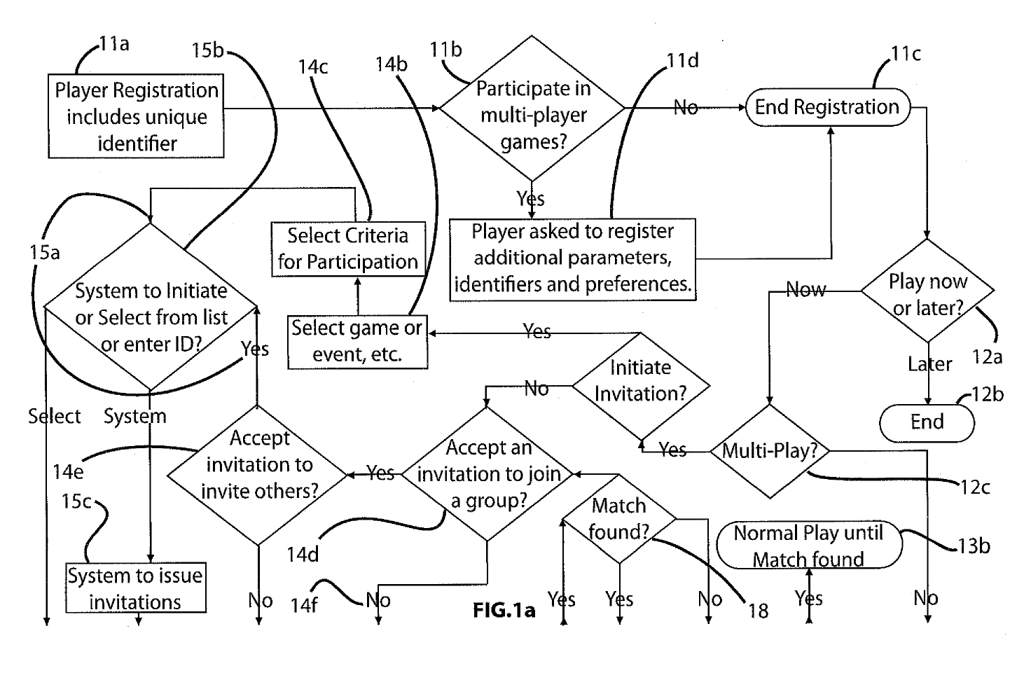

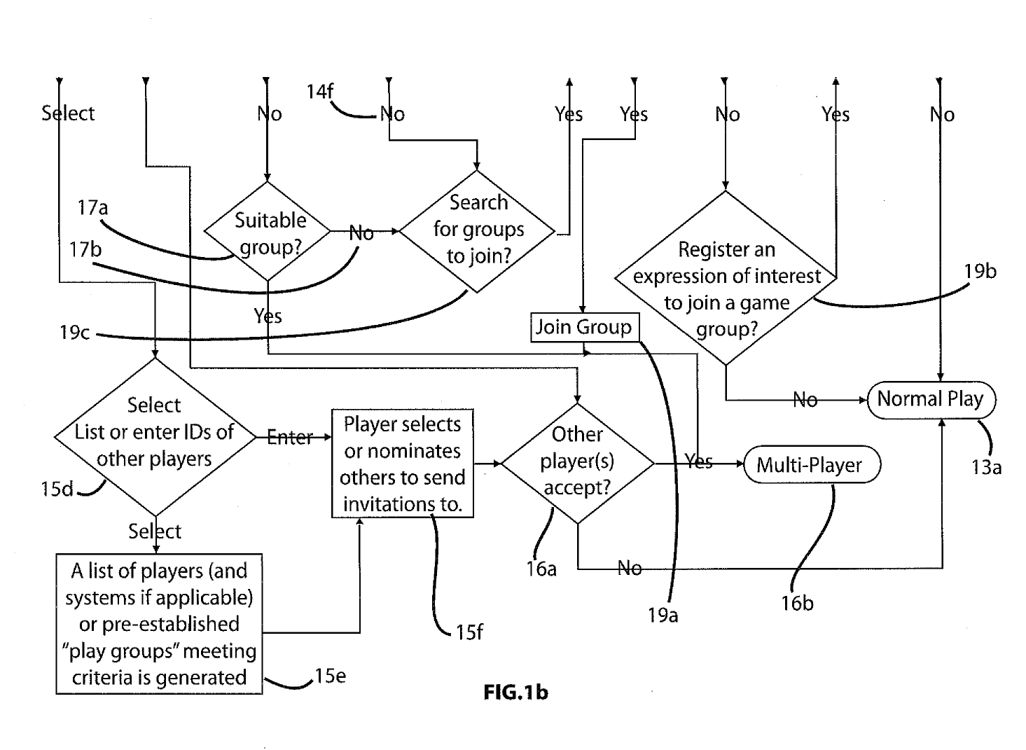

As shown in FIG. 1, the invention includes a set-up process which enables the players to register themselves in the system and setup their profiles. A domain is a virtual establishment having back-end servers or computers, or may be an electronic interface representing a gaming facility and published on an electronic network. The domain may send the registration information to an in-house (local) or third-party (distant) server, that adds the information to a database. The domain is thus said to be associated or in communication with the server. Operators of different gaming domains may decide to link their systems so that their players can play together. The registration database, therefore, may contain information from several systems. In one scenario, the player is registered on a single or multi-user gambling domain under a unique handle, name, or identifier, by which they might be identified on the system to other players 11a. The system may also allow temporary unique handles that are associated with anonymous registrations. For example, people from a tour bus from Atlanta may be registered by their group leader and given handles like AtlantaBus-1, AtlantaBus-2, etc.

As part of the registration process the player may be asked if they wish to participate in multi-player games 11b. If the player does not wish to participate in multi-player games, the registration in complete 11c. Otherwise, they may choose a preset multi-play profile, or provide additional parameters to register their own preferences 11d. Therefore, each player's profiled stored in the database may comprise a multi-play profile in addition to a personal profile.

The additional parameters might include the player's additional identifiers, if the player is known as more than one unique name or handle on the system. For example, the same player may have the ID “pokerguy” in a poker play group and the ID “Blackjacking” in a blackjack play group. They can also set preferences for game types, rules of play, parameters for selecting invitees, criteria for establishing an invitee's right to invite other participants, or other preferences. After registration, the player can choose whether to participate right away 12a. The player's current visit ends if he or she does not wish to participate 12b, and may commence playing at any time in the future. The player needs only complete the registration process once, but may modify their preferences for all registration parameters 11d at any time.

A player wishing to participate in a game or an event will sign on to the system, by entering his or her ID and perhaps a password, or by swiping a card or scanning a bar-code. Before a player starts playing, he or she is given the choice of partaking in a multi-player event 12c. The player can enter into normal single player games 13a if he or she wishes. A player who currently wants to participate in a multi-player event can choose whether to initiate his or her own group 14a. If the player wishes to initiate a play group, he or she will choose a game or event that the group will participate in 14b. The player will then choose the criteria for selecting invitees 14c. A group-initiating player may be given the choice of keeping the group open to all the players, or to a set of players. For example, he or she may keep the group open to players who play in New York City on Friday nights, so that those who fit this criterion can join without invitations. Alternatively, the player may choose to admit only those who have received invitations, or send out invitations to selected invitees while keeping the group open. The player can proceed to generate the invitee list 15a if he or she wishes to send out invitations. Alternatively, rather than starting a new group, the player may accept any existing invitation to join a group 14d. In some embodiments, the player may be presented with a pop-up box with messages such as “You have 3 invitations” after signing-in, if he or she happens to have been invited to three groups, from which a preferred invitation may be chosen. The system may also offer functions such as to view all or new invitations, or delete declined invitations.

If the player accepts an invitation to join a group 14d, he or she may choose whether or not to invite other players to join this group 14e, if such privilege has been extended. If the player wishes to invite others, then he or she will also proceed to generate the invitee list 15a. In one embodiment, if the player does not invite others into the group that he or she has selected to join, he or she has a chance to reconsider joining the group by confirming whether or not the said group is suitable 17a.

Once the player proceeds to generate the invitee list 15a, the system compares its available registration database against the player's invitee selection criteria, and compiles an invitee ID list. Given this list, the player can decide how he or she will choose the invitees 15b. This may be done at a kiosk, a help-desk, or directly on the machines. In one embodiment, the player can choose an automated process where an invitation is sent to everyone included in the system-compiled invitee ID list 15c. The player can also perform manual selection 15d. This can be done by hand-picking IDs from the system-generated suitable invitee list or from a list of pre-established playgroups 15e. For example, the player may choose to invite everyone from the “poker group”. Either as an alternative or an addition, the player may directly nominate invitees 15f. In one embodiment, this nomination may be done when the player provides the invitees' IDs or handles. In another embodiment, the player may swipe a card at a kiosk or a machine, and ask the intended invitees to swipe their cards at the same kiosk or machine.

In some embodiments, the play-group initiating player can also grant one or more other players the same rights (similar to computer application access control rights and analogous to a “super user”) as him or herself, to invite other players to the group.

The invitations may be sent out via email, or as alerts that pop-up when the invited players sign on to the system. It is also possible that a modifiable “invitation” table is included in a player's profile, such that any new invitation can be inserted into the player's entry in the database.

After the invitations are sent out, the initiating player awaits responses from the invitees 16a. If anyone accepts the invitation, the players can proceed to play the chosen multi-player game or event 16b. In the alternative, a scheduled time in the future can be set for the multi-player game or event to commence. If no one accepts the invitation, the players can proceed to play normal single-player games 13a.

In the event that the player finds the present group unsuitable 17b, or initiates no invitation nor accepts any invitation to join any group 14f, he or she may search any “open” invitations for potential groups to join 17c, and see if a match is found 18. The match criteria can be, but not limited to, keywords such as “poker, Friday night”, checked items on multiple choice forms, or the data entered during the player's initial registration.

If no match is found, the player can register interest to join a group that he or she is not presently invited to or does not yet exist 19b, and start a normal single-player event while waiting for his or her interest to be answered 13b. Otherwise, the player can proceed to participate in normal single-player events 13a if he or she does not register any interest to join groups.

The above teaching relates to a group that plays among itself, possibly using a casino's or game operator's infrastructure. Thus the casino or operator requires compensation, and this can be in the form of a fee payable by the participating players. The fee may be based on the number of games or bonds played, or based on a percentage of a player's stake or their winnings, or based on a period of time, like a subscription or membership fee.

Also, because the players are competing against one another in the nature of a tournament, and not against the casino or operators, the reward to the winner or winners is generated from the money gambled by the players. It is understood that practically any game may be played as a tournament. Some games will have an outcome that determines the winner(s) and the distribution as a matter of course. For example, in a poker tournament, a player's chip count at the end of play (timed or otherwise) indicates their financial position with respect to the other players. However the same game may be played so that the point, chip, or financial leader at the end of play (timed or otherwise) wins a fixed prize, or a prize based on other factors, such as the amounts in the total stakes of the players in the group. It will be understood that the casino or operator may recuperate compensation from a player's stake, or the player's winning, or by agreement in advance of play.

Since different systems are allowed to be involved in the multi-player system, the operator of one system may negotiate a profit from the operator of another system by providing that system with his or her client base. It is also possible that third-party facilitators or agents may negotiate deals and receive payments for introducing players to gaming, betting, or gambling systems. For example the leader of a tourist group may bring in people in the group to be players in a gaming system, and collect a fee for doing so. In another example, a person or a company who facilitates or implements a “grouping technology” to enable different systems to be linked together may also receive fees.

In the event where multiple systems are involved, the player would be identified by a combination of both their home system ID and the system ID.

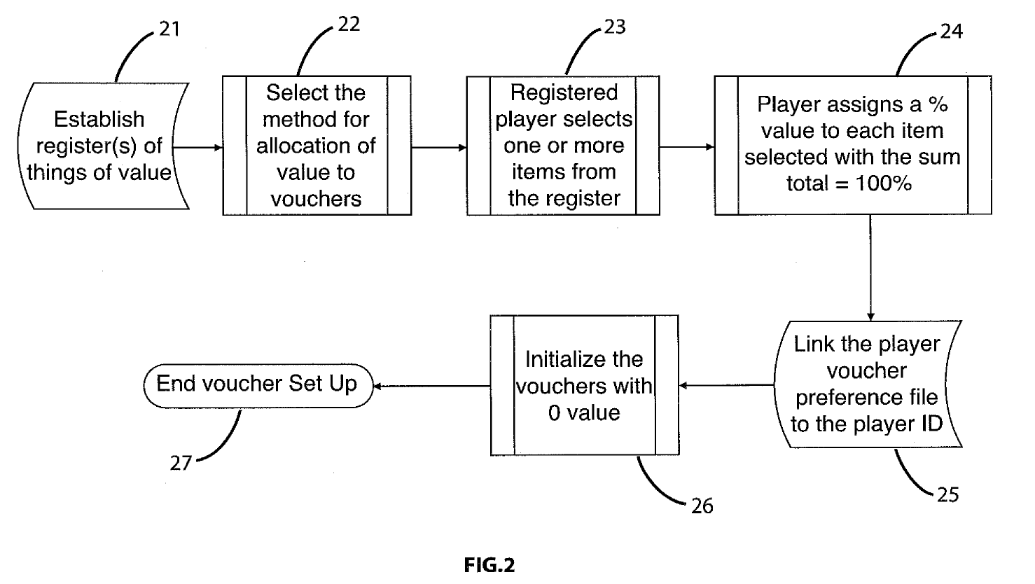

Referring to FIG. 2, it is envisaged that the following processes would be programmed into one or more software modules (hereinafter called the “module”) that would constitute a “plug in” or a component of a player loyalty or gambling, gaming, sportsbetting, wagering or other technology assisted gambling program, application or system.

The module could provide for a register of goods and services or other things of value. The thing(s) of value in the register are populated by the operator of the system. This register may contain sub-registers. For example the first register might be category (e.g. sports), the second register may be a sub-category (e.g. footwear), the third register might be the name of a store or manufacturer of footwear, while the forth register might be the type of footwear, and the fifth, a photo of the actual product with a recommended retail price or other appropriate information 21. In some examples, the creation of the registry can be done by having the player or a help-desk personnel enter the data into an on-line form, which is then fed into the database. Or a help-desk or administrative personnel may directly add the entry into the database, using the player ID as the key identifier.

After the registry is established, the system operator may designate a voucher-earning paradigm for the player 22. For example, the player receives 1% of the total money bet as the voucher credit. There may be rules as to what paradigms are used for which users. For instance, there could be a tier-system like an air carrier's air-miles reward scheme, where a player gets more reward points after they have spent a certain amount of money. In some other examples, the operator may offer a range of paradigms for a certain user to choose from.

A registered player can control how the sum total of credits is allocated for his or her electronic voucher(s). Then the player may select one or more items from the register(s) 23. The player may then allocate a percentage not less than 0% and not greater than 100% to each selected item and where the sum of the percentage allocation of each item must equal 100% 24. The module may or may not limit the number of items to be selected. Once an item is selected a percentage allocated, an electronic voucher for this item has been established. Electronic vouchers may be converted into coupons which players can use at the applicable vendors.

A player's original electronic voucher set-up might be electronically linked to the player's ID, which indexes his or her database entry on the server 25. Before the player earns any electronic voucher credit, all the electronic vouchers are initialized with zero credit 26. The set-up is complete after the credit-initialization 27.

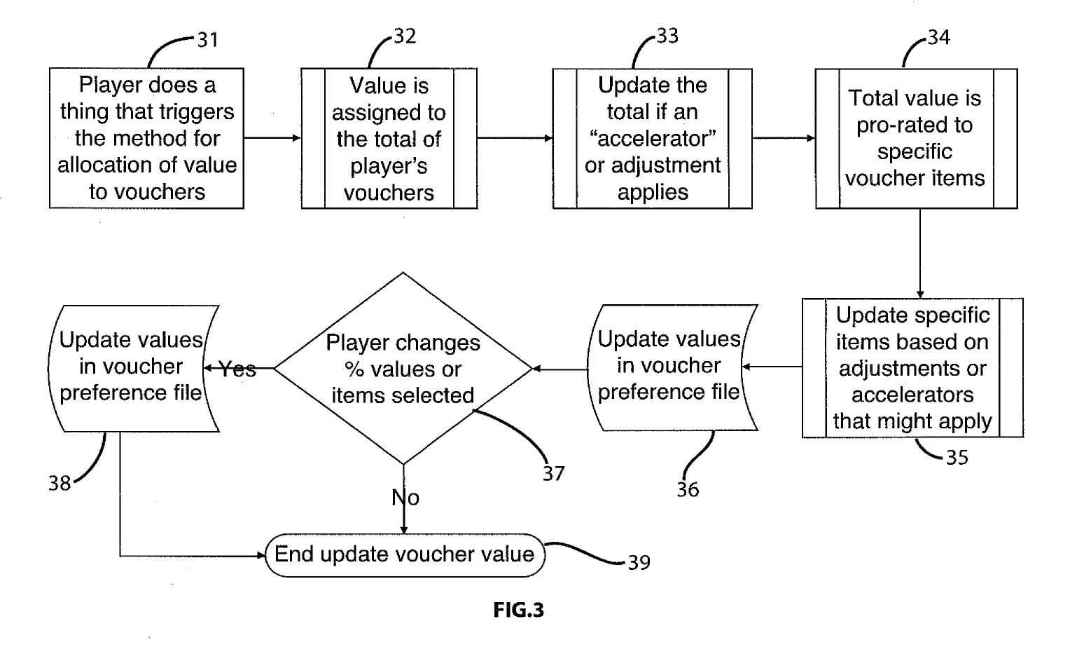

Referring to FIG. 3, the module(s) allow updates to be made to the electronic voucher credits, either by the participating player or by the operators.

To starts earning electronic voucher credits, the player may perform an action, such as betting, winning, or taking a loss, depending on how the he or she is supposed to attain electronic voucher credits 31. The value will then be assigned to the player's vouchers(s) 32. For example, if the total money bet is $100.00 and the entire electronic voucher allocation is 1% of total money bet, then the total credit of the accumulated electronic vouchers will be $1.

The operator of the system can adjust the amount, or “accelerate” the earning rate of, total electronic voucher credits owned by a player (perhaps from the promotional budget), or both 33. For example, the system operator may add x dollars to the total electronic voucher credit, or increase the rate at which a player earns the total electronic voucher value from y % to z % of total money bet. After adjustments, if any, the total electronic voucher credit will be pro-rated to individual electronic voucher items according to the player's registered profile 34. For example, if a player's total electronic voucher credit is $1, and if 60% of the total electronic voucher credit is allocated to electronic voucher #1 for a coffee at the casino's café, then the value of that electronic voucher will be 60c.

The operator of the system can also adjust the amount, or “accelerate” the earning rate of, individual electronic vouchers owned by a player (perhaps from the promotional budget), or both 35. Once such an action is taken, the specific electronic voucher setting is changed in this player's profile 36. For example, if a player earns 1% of all money bet, and allocates 60% of the rewards to the coffee voucher, then 60c toward the coffee voucher is made from $100 of bets. The system operator may reward a 20c bonus which applies only to this coffee voucher to increase its values to 80c. In another scenario, the system operator accelerates the earning rate to 2% just for the coffee voucher, such that its value becomes $1.20, but no other voucher values are changed.

The preferences of a player may change over time. The module hence permits the player to modify percentage allocations at any time and to reassign or consolidate accumulated values associated with vouchers 37. In some embodiments, bonuses added to individual electronic vouchers will not be re-allocated towards other vouchers. Using the player's ID as a link or a key, any desired changes to the electronic voucher profile can be made into the player's database entry 38. If there are no further changes to the electronic voucher values, the electronic voucher profile update is complete 39.

The updating process can be repeated whenever the players wish to change their settings, or participate in an event in the prescribed manner so as to earn electronic voucher credits.

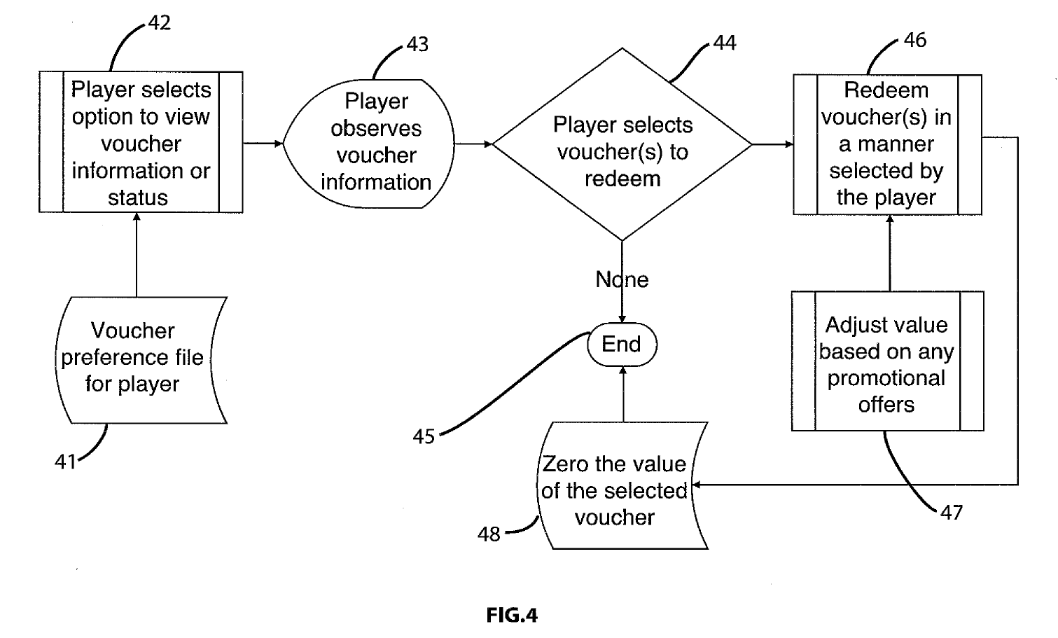

Referring to FIG. 4, the players can view the status of their electronic vouchers. The system displays the player's registration profile for him or her to review 41. In particular he or she can then select the option of viewing the electronic voucher profile, which contains any updates in electronic voucher credits previously made 42. The player can then view the latest electronic voucher profile 43. This mechanism may be done at a kiosk, a help-desk, through a web-site, or possibly via a display on the gambling device where the player selects the voucher(s) they are interested in. The electronic voucher credits may be presented in numbers, or in bars charts or other visual displays. Or the players can view the electronic voucher credits in a meter or speedometer on screen while they play. For instance, the system's computer can retrieve the database entry, having the correct player ID, on the server.

After viewing the latest electronic voucher profile 43, the player can choose whether to collect any coupons 44. This might be through printing out coupons at a kiosk, or more preferably electronically through the use of a player ID, smart card or other device. The viewing/collection process is complete if the player decides not to collect any coupons 45. Alternatively, the player can collect coupon(s) in a manner convenient to him or her 46.

The modules will let the provider of the goods or service offer promotional deals to the players who (opt in) for marketing material. Such offers may be via e-mail or through the mail or through system broadcasts. If participating players receive promotional offers, the applicable voucher value will be changed 47. For example, the casino's movie theatre might scroll a message on the screen of the gaming device that for the next 12 hours they will honor double the value of any voucher.

In some embodiments, the collected coupons may have an expiry date, by which time the credit of the collected coupons may be lost, or reinstated back to the player's account according to his or her latest electronic voucher credit allocation, if the coupons are not yet redeemed at the applicable vendors. If extra credit was added to the expired coupon when it was collected, as a special offer, for example, the extra credit may or may not be reinstated, depending on the policy of the operators or vendors.

The values of the vouchers(s) will be modified to be the original amount less the used (i.e. collected) amount 48. For example, given a coffee is worth $1 and a player has $6 worth of credits already allocated to the coffee voucher, if the player decides only to collect enough coupon for 2 coffees, he or she will have $4 of credits left for the coffee voucher to be collected at another time. If the $2 collected coffee coupon expires without being redeemed, the $2 worth of credit may be reinstated so that the player again has $6 worth of credit for the coffee voucher in his or her electronic voucher profile.

The above teaching relates to an electronic voucher scheme that produce rewards for players, as well as financial gains for the casinos or operators in forms such as increased player spending and promotion fees.

The scheme employed in the above teaching may be utilized by vendors as a tool of learning about consumer habits, in addition to being a tool of generating more retail transactions.

Depending on arrangements between vendors and the casino or operators, a fee payable to the casino or operators may be made by a vendor wishing to have their product listed as one of the reward items, or by a vendor who wishes to have promotional features or special offers advertised by the casino or operators to players ready to redeem their vouchers.

It is understood that reward schemes, by nature, may encourage higher player spending. For example, a player may be encouraged by the rewards to stay longer at a casino such that one more night's stay at the casino or the establishment's hotel or more meals at the casino or establishment's restaurants may be required. The casino or operator may receive increased fees from shops inside the establishment, in the form of a percentage of increased gross retail values, or in the form of increased rental values on the grounds of higher consumer spending.

While the present invention has been disclosed with reference to particular details of construction, these should be understood as having been provided by way of example and not as limitations to the scope or spirit of the invention.

What is claimed is:

1. A multi player networked gaming system, comprising:
a gaming domain associated with a server;
the domain being adapted to collect player profile information and communicate the information to a database of player profiles;
each player profile being indexed by a unique identifier;
the player profile further comprising a personal and a multi-play profile;
database being modifiable by the server;
the personal profile containing a player's personal information, and the multi-play profile containing the player's multi-play information;
the system further comprising a multi-player module;
the multi-player module presenting the player with a choice to initiate a play group and invite other players to join that play group.

2. The system of claim 1, wherein,
the database contains a player profile from another gaming domain.

3. The system of claim 1, wherein,
the multi-play profile further comprises one or more multi-play preference parameters, one or more invitee selection criteria, and a modifiable invitation table.

4. The system of claim 3, wherein,
the multi-player module is adapted to compile an invitee list by matching the player's invitee selection criteria against the player profile database.

5. The system of claim 4, wherein,
the player's selection of an invitee whose identifier is included the invitee list triggers the multi-player module to issue a message to the invitee.

6. The system of claim 5, wherein,
the player gives the invitee the privilege to trigger a delivery of an invitation to another player.

7. The system of claim 1, wherein,
the system further comprises a player registration module, the player registration module accepting an initialisation or modification of the player's profile and transmitting the initialisation or modification to the server.

8. The system of claim 1, wherein,
the system further comprises a sign-on module that allows the player to enter the system.

9. The system of claim 1, wherein,
the gaming domain is a virtual casino.

10. The system of claim 1, wherein,
the system further comprises a reward program that has an electronic voucher system.

11. A method for an operator to host a multi-player gaming system, comprising the steps of:
administering a gaming domain that is in communication with a server, wherein the server has read and write access to a player profile database;
the server assigning a unique identifier to a player that plays within the gaming domain;
authorising the transmission of the player's profile from the system's registration module to the database via server;
enabling the player to initiate a new play group; and
enabling the player to trigger an electronic invitation to be delivered to another player on the server, wherein the electronic invitation inviting the other player to join the new play group.

12. The method of claim 11, wherein, the operator enables the system to be linked to another gaming domain.

13. The method of claim 12, wherein,
the operator receives a commission from an operator of the other gaming domain.

14. The method of claim 11, wherein,
the operator commissions a reward program that comprises an electronic voucher system.

15. The method of claim 11, wherein,
the operator receives a commission from players of the new or existing play group.

16. A method of administering an electronic voucher system, comprising the steps of:
establishing an electronic register of goods and services;
administering and updating a voucher preference profile for a player, wherein the profile is linked to the player via a unique player identifier;
a total voucher value being prorated to the player's choice of specific voucher items, each item being a good or service included in the register;
designating a voucher-earning paradigm for the player;
issuing a physical coupon to the player, wherein the coupon is redeemable for a corresponding voucher item.

17. The system of claim 16, wherein,
the register is divided into sub-registers based on the goods and services.

18. The system of claim 16, wherein,
a percentage of a total amount of money bet or won is allocated toward the player's voucher credits.

19. The system of claim 16, wherein,
the operator adjusts an allocation of total or individual voucher credits by way of a promotional offer.

20. The system of claim 16, wherein,
the operator enables the viewing of the voucher or the collection of the coupon from a networked machine.
